(19) United States
(12) Patent Application Publication
(10) Pub. No.: US 2017/0211467 A1
(43) Pub. Date: Jul. 27, 2017

(54) FREEWHEEL CLUTCH FOR SUPERCHARGER RESONANCE REDUCTION

(71) Applicant: Accessible Technologies, Inc., Lenexa, KS (US)

(72) Inventors: Cliff Hall, Lee's Summit, MO (US); Clint A. Rucker, Lenexa, KS (US)

(21) Appl. No.: 15/413,712

(22) Filed: Jan. 24, 2017

Related U.S. Application Data
(60) Provisional application No. 62/286,668, filed on Jan. 25, 2016.

(51) Int. Cl. F02B 39/04; F16H 7/02; F02B 39/16; F02B 33/40; F02B 29/04; F16H 9/18; F16D 41/069

(52) U.S. Cl. CPC F02B 39/04; F16H 9/18; F16H 7/02; F16D 41/069; F02B 33/40; F02B 29/0425; F02B 39/16; F16D 2300/22

(57) ABSTRACT

A supercharger system includes an impeller, a compressor housing, an input shaft, an input pulley assembly, and a freewheel clutch. The impeller is for acquiring air. The compressor housing surrounds at least a portion of the impeller so as to direct the acquired air toward an internal combustion engine. The input shaft is configured to rotate the impeller. The input pulley assembly is configured to drive the input shaft and interface with a serpentine belt that is associated with the power source. The input pulley is configured to rotate in a primary direction correlating with rotation of the serpentine belt in the primary direction. The freewheel clutch is configured to interface with an input shaft of the supercharger, wherein the freewheel clutch prevents rotation in a reverse direction that is opposite the primary direction.

### RELATED APPLICATIONS

This non-provisional patent application claims priority benefit, with regard to all common subject matter, of earlier-filed U.S. Provisional Patent Application No. 62/286,668, filed on Jan. 25, 2016, and entitled “FREEWHEEL CLUTCH FOR SUPERCHARGER RESONANCE REDUCTION.” The identified earlier-filed provisional patent application is hereby incorporated by reference in its entirety into the present application.

### BACKGROUND

1. FIELD

Embodiments of the invention broadly relate to superchargers. More particularly, embodiments of the invention are broadly directed to systems and methods for reducing resonance generated at the supercharger.

2. RELATED ART

Superchargers increase power and work performance of power sources, such as internal combustion engines. Superchargers act as an air compressor that increases the air pressure and/or air density fed into the internal combustion engine. The increased amount of air allows the internal combustion engine to burn more fuel. The internal combustion engine itself typically powers the supercharger via a serpentine belt, gear, or the like.

Superchargers of the prior art have a common problem when the power source is at low speeds (measured in rotations per minute or “RPMs”), such as at engine idle. The operation of the power source imparts certain intermittent impulses onto a crank pulley. These impulses may be minor, momentary reversals of direction and torsional excitation. The impulses are thereafter transferred to internal timing gears of the supercharger via a serpentine belt and an input pulley. The impulses cause a rattling, knocking, or banging together (generally “resonance” as discussed below) of the internal timing gears based in part on play between the timing gears. The rattling may be able to be heard from the exterior of the vehicle and from within the cab of the vehicle. The rattling may also be felt in the cab, such as at the steering wheel.

### SUMMARY

Embodiments of the invention solve these problems by providing a freewheel clutch that prevents the impulses from inducing a rotation in a reverse direction that is opposite a primary direction of rotation. In some embodiments, the freewheel clutch is added to an input pulley. In other embodiments, the freewheel clutch is added to the interior of a gear case of the supercharger. Embodiments of the invention utilize the freewheel clutch to prevent reverse rotation. The freewheel clutch may be a sprag clutch, a roller clutch, a pawl and ratchet clutch, or the like. Freewheel clutches allow free rotation in one direction and prevent rotation in a second direction (opposite the first direction). The freewheel clutch prevents or reduces the above-discussed resonance generated by superchargers of the prior art.

A first embodiment of the invention is directed to a supercharger system configured to be installed in a vehicle having a power source, the super charger system comprising an impeller, a compressor housing, an input shaft, an input pulley assembly, and a freewheel clutch. The impeller is for acquiring air. The compressor housing surrounds at least a portion of the impeller so as to direct the acquired air toward an internal combustion engine. The input shaft is configured to rotate the impeller. The input pulley assembly is configured to drive the input shaft and interface with a serpentine belt that is associated with the power source. The input pulley is configured to rotate in a primary direction correlating with rotation of the serpentine belt in the primary direction. The freewheel clutch is configured to interface with an input shaft of the supercharger, wherein the freewheel clutch prevents rotation in a reverse direction that is opposite the primary direction.

A second embodiment of the invention is directed to input pulley assembly configured for providing power to a supercharger for an internal combustion engine, the input pulley assembly comprising an input pulley and a freewheel clutch. The input pulley is configured to interface with a serpentine belt, and is configured to rotate in a primary direction correlating with rotation of the serpentine belt in the primary direction. The freewheel clutch is configured to interface with an input shaft of the supercharger The freewheel clutch is configured to prevent the input shaft from rotating in a reverse direction that is opposite the primary direction.

A third embodiment of the invention is directed to a method of reducing resonance in a supercharger system, the method comprising the following steps: inserting a freewheel clutch into an input pulley; securing the freewheel clutch to the input pulley by applying a pulley sleeve into the freewheel clutch; securing an input pulley assembly to an input shaft of the supercharger system; securing a serpentine belt around the input pulley assembly and a crank shaft associated with a power source, wherein the serpentine belt is configured to drive the input pulley assembly in a primary direction, wherein the freewheel clutch is configured to prevent the input shaft from rotating in a reverse direction that is opposite the primary direction.

Additional embodiments of the invention are directed to a vehicle comprising a chassis, a power system, and a supercharger system. Still another embodiment of the invention may be directed to a gear case for a supercharger system, wherein the gear case comprises a set of gears, an input shaft, an input pulley assembly, and a freewheel clutch.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a side view of a supercharger system according to some embodiments of the invention, as illustrated from a compressor housing side;

FIG. 2 is a side view of the supercharger system of FIG. 1, as illustrated from an input pulley side;

FIG. 3 is a schematic system view of the supercharger system as a component of an engine power system;

FIG. 4 is a vertical cross-section view of the supercharger system of FIG. 1, illustrating a variable ratio configuration;

FIG. 5 is a vertical cross-section view of the supercharger system of FIG. 1, illustrating an input shaft and an input pulley assembly;

FIG. 6 is a vertical cross-section view of a supercharger system according to other embodiments of the invention, illustrating a fixed ratio configuration;

FIG. 7 is a perspective view of an input shaft and an input pulley assembly;

FIG. 8 is a perspective view of the input pulley assembly as shown from a first side;

FIG. 9 is a perspective view of the input pulley assembly of FIG. 8B, as shown from a second side;

FIG. 10 is a perspective view of an exemplary pulley sleeve;

FIG. 11 is a vertical cross-section view of the input pulley assembly, illustrating a dual freewheel clutch

FIG. 12A is a cross-sectional view of the freewheel clutch illustrating sprags therein and presenting an annular view of the internal components of the dual freewheel clutch;

FIG. 12B is an exterior side view of the dual freewheel clutch illustrating the adjacent components;

FIG. 12C is a vertical cross-section view of the dual freewheel clutch illustrating a roller segment and a clutch segment; and

FIG. 13 is a vertical cross-section view illustrating a unitary freewheel clutch.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

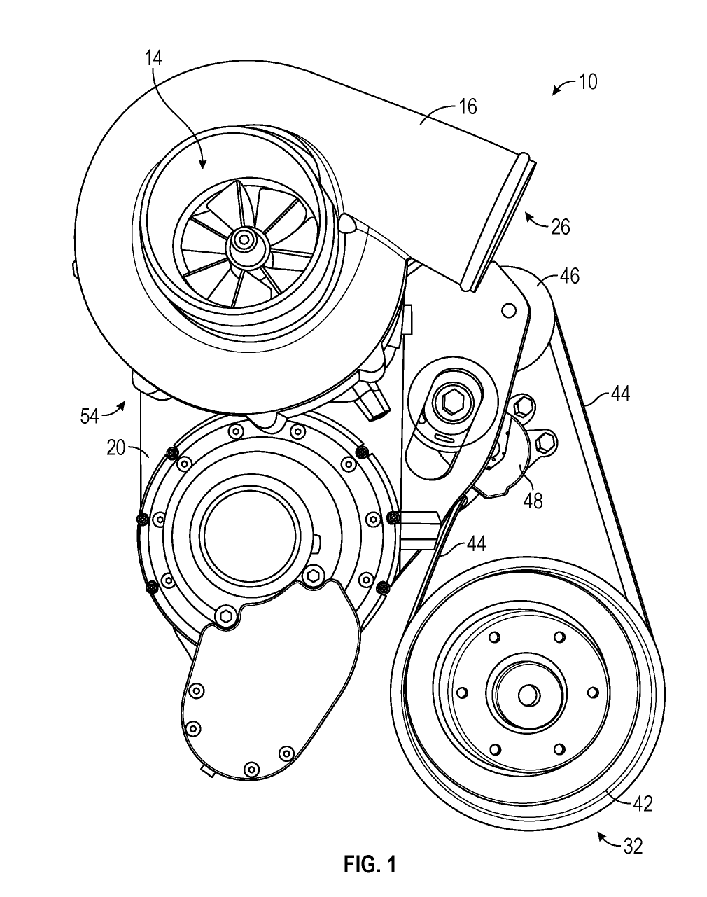

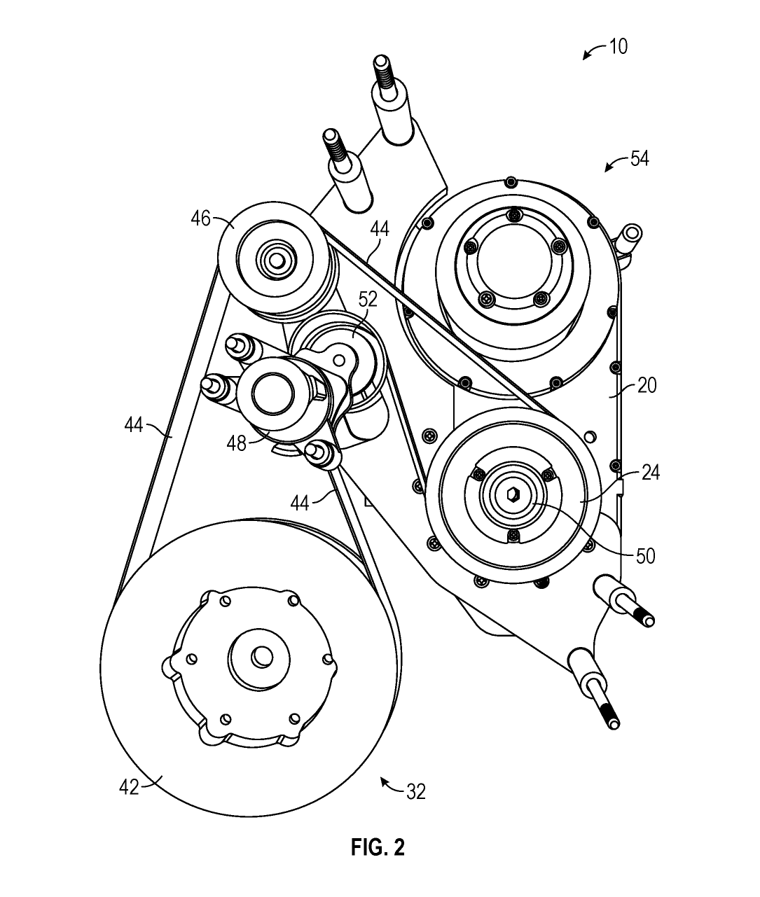

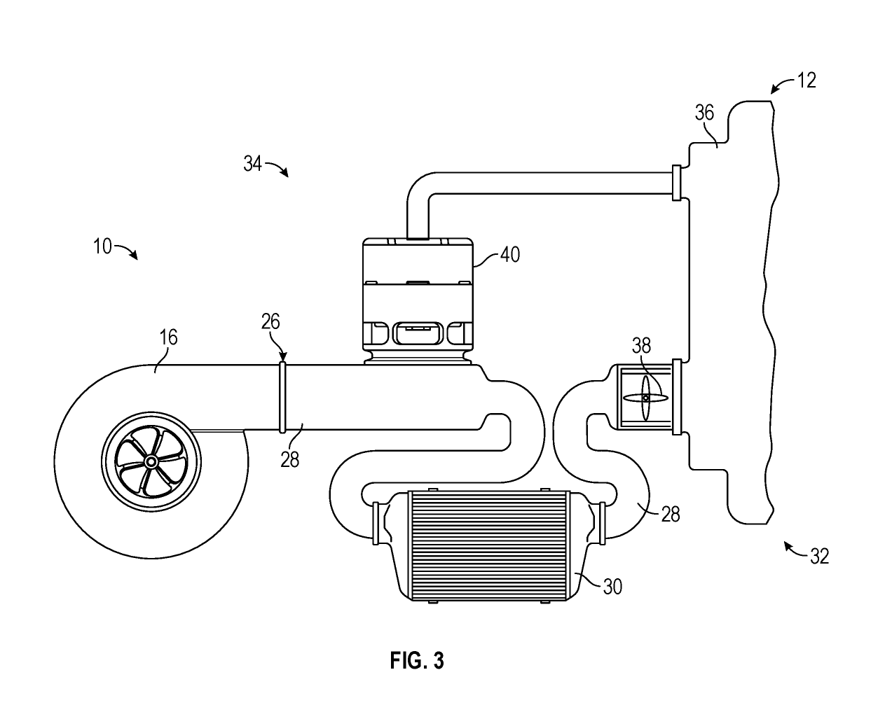

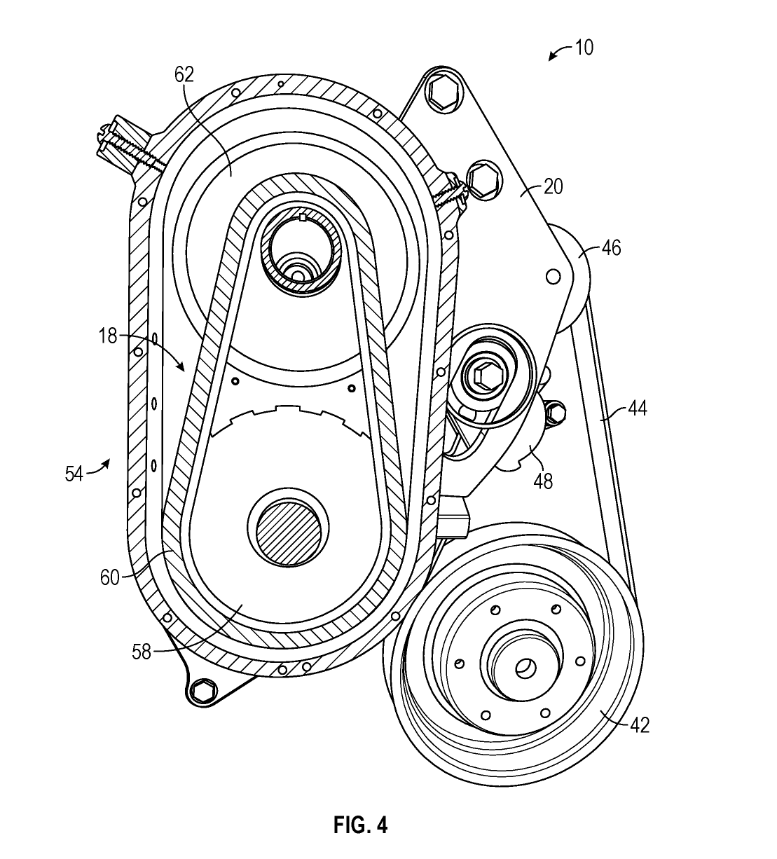

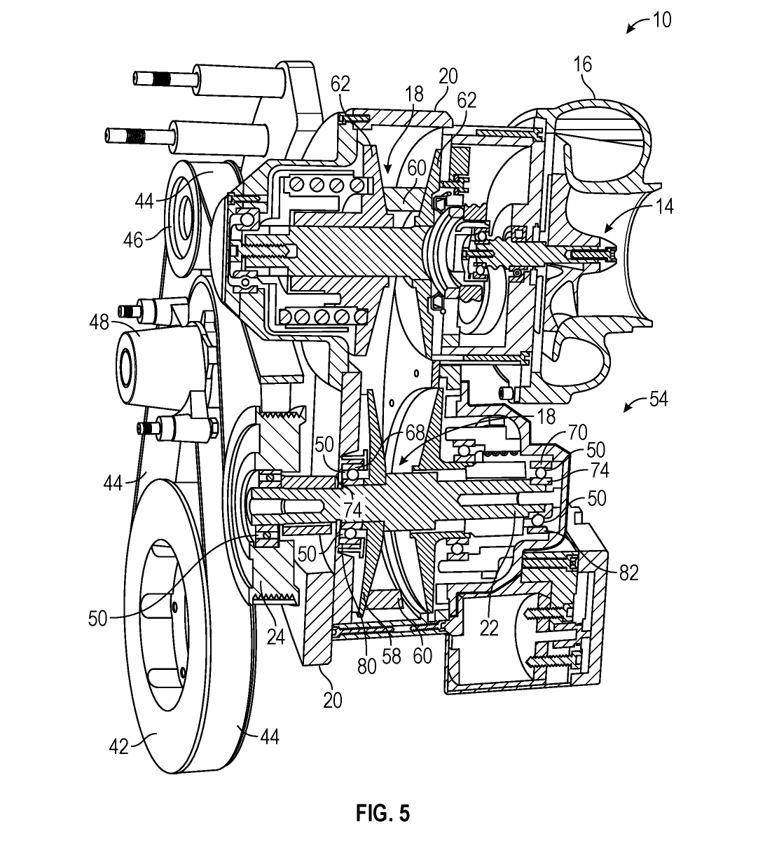

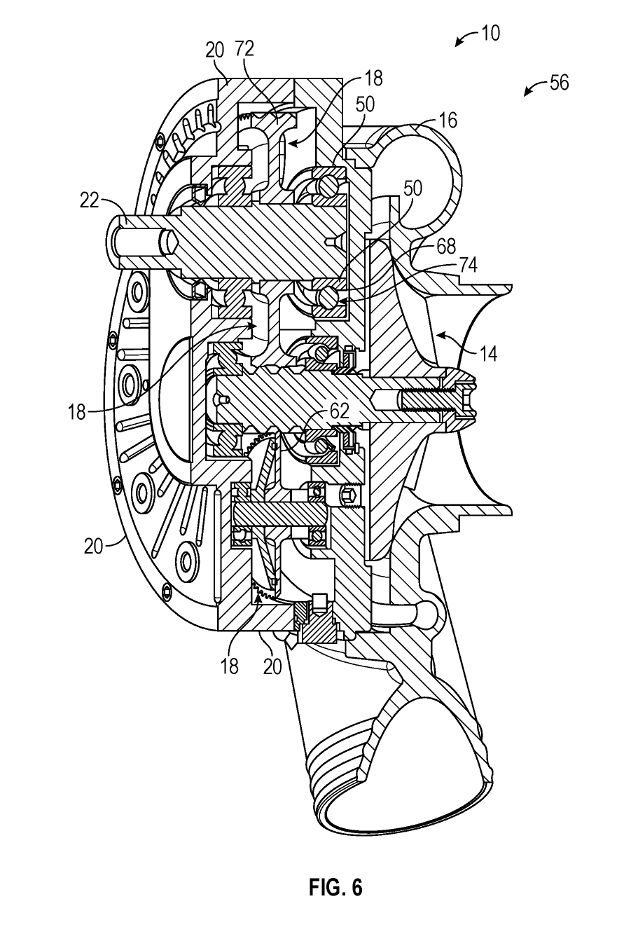

Turning to the figures, a supercharger system 10 is shown in FIGS. 1 and 2. Generally, the supercharger system 10 is configured to provide additional air to an internal combustion engine 12 or other power source 32 that utilizes oxygen for combustion. In embodiments of the invention, the supercharger system 10 broadly comprises an impeller 14, a compressor housing 16 (also known as a volute), a set of timing gears 18 (shown in FIGS. 4 and 6), a gear case 20, an input shaft 22 (shown in FIGS. 5 and 7), and an input pulley assembly 24. The impeller 14 rotates rapidly so as to draw air into the compressor housing 16. The compressor housing 16 directs the air towards an air outlet 26. The air outlet 26 of the compressor housing 16 is secured to a duct 28, pipe, or the like (shown in FIG. 3). The duct 28 may run through an intercooler 30 (shown in FIG. 3) to cool the air before it is fed into the internal combustion engine 12. The impeller 14 of the supercharger system 10 is powered by the timing gears 18, as discussed below and shown in FIG. 4. The timing gears 18 are powered by the rotation of the input shaft 22 and the input pulley 24. Each of these components is discussed in more depth below.

A supercharger system 10 of embodiments of the invention may be used with a power source 32, such as an internal combustion engine 12 or an electric motor. A supercharger system 10 configured to be added to an internal combustion engine 12 will be primarily discussed herein, although this should not be limiting on the type of power source 32 used. The supercharger system 10 provides additional air into the internal combustion engine 12. As such, the supercharger system 10 generates airflow and directs the airflow into the internal combustion engine 12. This allows the internal combustion engine 12 to burn more fuel, as air (and specifically oxygen) is necessary for combustion. It should be appreciated that in some embodiments of the invention, the power source 32 which provides power to the supercharger system 10 is the same as the internal combustion engine 12 to which the supercharger system 10 is directing airflow. In these embodiments, the supercharger system 10 has a parasitic effect on the internal combustion engine 12. In other embodiments, the power source 32 which provides power to the supercharger system 10 may be different than the internal combustion engine 12 to which the supercharger system 10 is directing airflow.

FIG. 3 illustrates the supercharger system 10 being integrated into a duct system 34 associated with an internal combustion engine 12. As illustrated in FIG. 3, the compressor housing 16 directs the air towards the air outlet 26. The air outlet 26 of the compressor housing 16 is secured to the duct 28, pipe, or the like. It should be appreciated that the duct system 34 as illustrated in FIG. 3 shows the duct system 34 in a schematic manner, but often the duct system 34 will be curved and angled to fit within the allowable engine compartment. The duct system 34 may run through the intercooler 30 to cool the air before it is fed into the internal combustion engine 12. The intercooler 30 may be adjacent to a grille of the vehicle such that entering air passes around the intercooler 30.

The duct system 34 contains the compressed air that is directed toward an engine manifold 36 or other component of the internal combustion engine 12. While a throttle 38 associated with the internal combustion engine 12 is open (as shown in solid lines in FIG. 3), compressed air from the duct system 34 is pushed into the internal combustion engine 12. When the throttle 38 is closed (as shown in dashed lines in FIG. 3), such as by the driver removing their foot from the accelerator, the compressed air within the duct system 34 needs to be removed. The compressed air is not needed because the throttle 38 being closed means that the excessive power (which the compressed air in the duct system 34 could provide) is not desired by the driver. Further, allowing compressed air to remain within the duct system 34 can be problematic, as discussed above. The duct system 34 may therefore include a blowoff valve 40 configured to release the excess air upon the throttle 38 closing. The blowoff valve 40 is in fluid communication with the engine manifold 36 such that a vacuum within the engine manifold 36 will open the blowoff valve 40 and allow the excess air to escape into the surrounding environment.

Returning to FIGS. 1 and 2, power is transferred to the supercharger system 10 by a crank pulley 42. FIG. 1 illustrates how power is transferred from the power source 32 (or other power source 32, such as an electronic motor) to the supercharger system 10. A serpentine belt 44 is routed through a crank pulley 42. The crank pulley 42 is rotated by the power source 32, which may be the internal combustion engine 12 or other power source 32. The crank pulley 42 therefore rotates in relation to the rotation of the power source 32. The serpentine belt 44 translates the rotation to the other various pulleys of the other components, such as an idler pulley 46, a tensioner pulley 48, and the input pulley 24 (which may include a freewheel clutch 50, as discussed in more detail below).

The idler pulley 46 is emplaced into a certain location. The location may be on the gear case 20, on the internal combustion engine 12, or on another component of the vehicle. The idler pulley 46 redirects the serpentine belt 44 to a desired position and orientation, such that it may be utilized by the input pulley 24 and/or other components. The tensioner pulley 48 has an associated actuator 52. The actuator 52, such as a spring, applies a pressure on the serpentine belt 44 that keeps the serpentine belt 44 taut as the serpentine belt 44 travels therearound. The tensioner pulley 48 may also be installed on the gear case 20, on the internal combustion engine 12, or on another component of the vehicle. In embodiments, both the idler pulley 46 and the tensioner pulley 48 are free spinning, such that power is neither added to the system or subtracted from the system by the idler pulley 46 and the tensioner pulley 48 (other than friction). In some embodiments of the invention, the idler pulley 46 and/or the tensioner pulley 48 may include the below-discussed freewheel clutch 50. The serpentine belt 44 therefore transfers the power from the crank pulley 42 to the input pulley 24 via the other various pulleys. In some embodiments, the power source 32 that is associated with the serpentine belt 44 is the internal combustion engine 12 that is associated with the supercharger system 10.

The crank pulley 42 generally rotates in a primary direction, e.g., a forward direction. At some or all rotation rates, the crank pulley 42 may generate or receive impulses from the power source 32. In a certain range (an example of which could be 600-1000 RPMs, such as at engine idle), the impulses may be a momentary, intermittent, or sudden change of direction in a reverse direction (that is opposite the primary direction). These impulses are therefore transferred to the serpentine belt 44 and thereafter to each of the other pulleys, including the input pulley 24. As such, the rotation of the input pulley 24 provides power to the interior components of the supercharger system 10, as discussed below. Embodiments of the invention therefore prevent, redirect, absorb, or otherwise reduce the impact of these impulses on the supercharger system 10.

Absent embodiments of the invention, these impulses could cause a mechanical resonance in the various components of the supercharger system 10. As used herein, “resonance” refers to unwanted vibrations and sounds. “Resonance” is intended to include gear wine, gear rattle, unwanted grinding, and other perceptible indications of the above-discussed impulses. “Resonance” can include a knocking, grinding, or rattling that is undesired and unnecessary for the operation of the supercharger system 10. The resonance may be noticeable audibly or may be felt by the operator via vibrations in various vehicle components such as a steering wheel, a seat, or a pedal (not illustrated). As such, the impulses do not create a resonance or the resonance is substantially reduced. This may include the resonance being imperceptible by the operator or being barely perceptible.

The supercharger system 10 of embodiments has a parasitic effect on the internal combustion engine 12. The supercharger system 10 draws its power from the power source 32, which may be the internal combustion engine 12 itself, via the serpentine belt 44 and the input pulley 24. However, the increase in engine performance from the supercharger system 10 makes up for the parasitic effects. The supercharger system 10 is therefore a net gain on power and output of the internal combustion engine 12, especially at higher rates.

FIGS. 4-6 show the interior components of exemplary superchargers with which embodiments of the invention may be utilized. FIGS. 4-5 illustrate embodiments of the invention related to a variable ratio supercharger 54 configured to set a ratio as desired by an operator. FIG. 6 illustrates embodiments of the invention related to a fixed ratio supercharger 56 that applies a fixed ratio of rotation based upon the relative dimensions of the drive gear 72 and the impeller 14 gear. It should be appreciated that embodiments of the invention could also be used with other types of superchargers. A spin ratio is defined as a ratio of a spin rate of the input shaft 22 to a spin rate of the impeller 14. In some embodiments of the invention, such as utilized with a fixed ratio supercharger 56, the spin ratio is fixed. In other embodiments of the invention, such as utilized with a variable ratio supercharge, the spin ratio is variable such that the spin ratio may be controlled, as discussed below).

A variable ratio supercharger 54, as illustrated in FIGS. 4 and 5, is configured to vary a ratio of input shaft 22 rotation to impeller 14 shaft rotation (e.g., the spin ratio). The ratio of input shaft 22 rotation to impeller 14 shaft rotation dictates the amount of air that will be fed into the internal combustion engine 12 by the supercharger system 10. By changing the spin ratio, the variable ratio supercharger 54 can adjust how much air is being fed into the internal combustion engine 12 to achieve a more precise performance. The variation in the spin ratio may be pre-determined or may be calculated based upon conditions. For example, the operator may be presented with an option for the desired variation. An example could include high acceleration of the spin ratio at low rates and then a steady high ratio at higher rates. Another example could include a more gradual increase in the spin ratio. Thus, the operator can select the desired change in the spin ratio based upon the requirements of a current or planned driving activity, managing fuel consumption, and other concerns.

In embodiments of the invention, the gear case 20 houses the timing gears 18. The timing gears 18 are powered by the input shaft 22 (which transfers the rotation of the input pulley 24). An input sheave 58 of the timing gears 18 (show in FIG. 4) is rotated by the input shaft 22. The input sheave 58 therefore rotates in the primary direction. The input sheave 58 imparts a rotation on a variable transition belt 60 (sometimes known as a continuous variable transition belt 60, or “CVT” belt). The variable transition belt 60 then translates the rotation to a driven gear 62. The driven gear 62 then translates the rotation to an impeller 14 shaft of the impeller 14. As discussed above, the impeller 14 then rotates so as to draw air into the compressor housing 16.

In embodiments of the invention, the timing gears 18 are formed of a specialized material in addition to or in the alternative to the use of the freewheel clutch 50. In embodiments of the invention at least a portion of the timing gears 18 are formed of aus-tempered ductile iron or other types of steel with a high-dampening capacity. Aus-tempering increases the strength of the material. The metallurgical properties of the iron dampens the resonance caused by contacting another gear. For example, gears formed of aus-tempered ductile iron may reduce the gear noise by twenty-sixty times. Aus-tempered ductile iron may therefore reduce or prevent the resonance when used in addition to or alternatively to the freewheel clutch 50.

In some embodiments of the invention, the freewheel clutch 50 is disposed between the input sheave 58 and the input shaft 22. In these embodiments, the freewheel clutch 50 prevents the intermittent impulses imparted from the input shaft 22 from being absorbed and transferred to the input sheave 58. The freewheel clutch 50 may be secured to the input sheave 58 and/or secured to the input shaft 22. The freewheel clutch 50 may additionally or alternatively be secured to the gear housing that is adjacent to the input sheave 58 and/or the input shaft 22, as discussed in more depth below.

The input shaft 22 is generally elongated so as to be disposed in a corresponding opening in the gear case 20, as best illustrated in FIGS. 5-7. The input shaft 22 is configured to be disposed within the gear case 20 so as to drive a set of timing gears 18. The input shaft 22 may include a void 64, an annular protrusion 66, and other structure configured to interface with the set of timing gears 18 so as to drive the set of timing gears 18. The input shaft 22 is typically permanently installed into the gear case 20 and permanently in contact with the set of timing gears 18.

FIG. 5 shows a vertical cross-section through the supercharger system 10 illustrating how the power is relayed from the serpentine belt 44 to the impeller 14. The serpentine belt 44 imparts a rotation on the input pulley 24 (which is describe in more detail below). This rotation in the primary direction is then imparted to the input shaft 22. The input shaft 22 then drives the timing gears 18 in the primary direction. The timing gears 18 drive the impeller 14. The impeller 14 then rotates to draw in air from the external environment and force that air toward the engine manifold 36 via the duct 28, as discussed above in relation to FIG. 3.

In one embodiment of the invention, as illustrated in FIG. 4, a first interior freewheel clutch 68 and a second interior freewheel clutch 70 are disposed around the input shaft 22. The impulses imparted on the input shaft 22 directly from the input pulley 24 are therefore absorbed by the first interior freewheel clutch 68 and the second interior freewheel clutch 70. However, the impulses in the input pulley 24 are prevented from being transferred to the input sheave 58 by the freewheel clutch 50 therebetween. The two freewheel clutches 50 allow the input shaft 22 to spin freely therein in the primary direction, but seize and prevent motion in the reverse direction. In this embodiment, the two freewheel clutches 50 distribute the load placed on them by the input shaft 22, which can be rotating very rapidly, such as up to 20,000 RPMs. This load can place significant strain on the freewheel clutch 50.

A fixed ratio supercharger 56, as illustrated in FIG. 6, is configured to keep a set ratio of the input shaft 22 rotation to the impeller 14 shaft rotation (e.g., the spin ratio). The fixed ratio supercharger 56 is a simpler construction, as the timing gears 18 (discussed below) apply only a fixed ratio to the impeller 14 shaft. The fixed ratio supercharger 56 may comprise an input shaft 22, a drive gear 72, a driven gear 62, and an impeller 14 shaft.

In some embodiments, such as in a fixed ratio supercharger 56, the input shaft 22 may rotate a drive gear 72 in lieu of the variable transition belt 60 and the input sheave 58, as shown in FIG. 4. In some embodiments, the drive gear 72 may be in direct contact with the driven gear 62. In other embodiments, there may be additional intermediary gears (not illustrated) between the drive gear 72 and the driven gear 62. The intermediary gears further alter the ratio of the input shaft 22 rotation to the impeller 14 shaft rotation.

The freewheel clutch 50 may be disposed at the center of the drive gear 72, so as to absorb the intermittent impulses placed on the drive gear 72 by the input shaft 22. In these embodiments, the driven gear 62 may rotate opposite of the direction of the rotation of the input sheave 58. However, for purposes of the present disclosure, the direction would nonetheless be in the “primary direction.” The term “primary direction” as used herein to describe the rotation of the various components of the supercharger system 10 refers to the direction in which the component is designed to rotate under power from the power source 32. The “reverse direction” as used herein relates to a direction that is counter the primary direction of rotation. In other embodiments, the freewheel clutch 50 may be disposed at the center of the driven gear 62.

In some embodiments, the freewheel clutch 50 is disposed between the input pulley 24 and the input shaft 22. In these embodiments, the freewheel clutch 50 prevents rotation of the input shaft 22 in the reverse direction. In these embodiments, the freewheel clutch 50 prevents the rotation of the input shaft 22 from being in the reverse direction by absorbing or otherwise preventing the impulses from being imparted to the input shaft 22. It should be appreciated that in various embodiments, the freewheel clutch 50 may be placed externally to the gear case 20 (as discussed below) and/or internally to the gear case 20 (as discussed above). The combination of interior freewheel clutches 74 and exterior freewheel clutches 76 may provide a secondary layer of impulse prevention. The combination of interior freewheel clutches 74 and exterior freewheel clutches 76 may also reduce the load on each freewheel clutch 50. It should also be appreciated that there may be more than one freewheel clutch 50 internally and more than one freewheel clutch 50 externally.

In embodiments of the invention, the system comprises a first freewheel clutch 78 and a second freewheel clutch 80. The first freewheel clutch 78 is disposed between the input pulley 24 and the input shaft 22. As such, the first freewheel clutch 78 prevents rotation of the input shaft 22 in the reverse direction. The second freewheel clutch 80 is disposed between the input shaft 22 and the set of timing gears 18. The second freewheel clutch 80 is configured to prevent rotations of the input shaft 22 in the reverse direction from being imparted on the set of timing gears 18.

In other embodiments, the system comprises the first freewheel clutch 78, the second freewheel clutch 80, and a third freewheel clutch 82. The first freewheel clutch 78 is disposed between the input pulley 24 and the input shaft 22. As such, the first freewheel clutch 78 prevents rotation of the input shaft 22 in the reverse direction. The second freewheel clutch 80 is disposed between the input shaft 22 and the set of timing gears 18. The second freewheel clutch 80 is configured to prevent rotations of the input shaft 22 in the reverse direction from being imparted on the set of timing gears 18. The third freewheel clutch 82 is disposed between the input shaft 22 and the set of timing gears 18, at a second location away from the second freewheel clutch 80. The third freewheel clutch 82 is configured to prevent rotations of the input shaft 22 in the reverse direction from being imparted on the set of timing gears 18. In embodiments of the invention, the third freewheel clutch 82 rotates about a common axis with the second freewheel clutch 80 (along with the input shaft 22). The second freewheel clutch 80 may be disposed on a first side of the drive gear 72, and the third freewheel clutch 82 may be disposed on a second side of the drive gear 72 that is opposite the first side.

FIG. 7 shows another embodiment of the invention, in which the freewheel clutch 50 is exterior to the supercharger system 10. In this embodiment, the freewheel clutch 50 is disposed between a pulley sleeve 84 and the input pulley 24. The freewheel clutch 50 allows the input pulley 24 to grasp and spin the pulley sleeve 84 in the primary direction but prevents imparting a force (e.g., allows for free spin) in the reverse direction. The freewheel clutch 50 therefore absorbs the impulses that cause the rattling found in most superchargers of the prior art.

While spinning in the primary direction, the input pulley 24 and the freewheel clutch 50 will impart a torque on the pulley sleeve 84 so as to rotate the input shaft 22 at the same (or substantially the same) rate. Impulses imparted on the input pulley 24, or other reverse-direction forces, will allow the input shaft 22 to free spin independently of the freewheel clutch 50, such that the impulse or force will not be transmitted to the pulley sleeve 84 or the input shaft 22 (or will be reduced). The pulley sleeve 84 is configured to be added to the input shaft 22 so as to allow the input pulley 24 of this embodiment to be added to existing superchargers. It should be noted that freewheel clutches 50 in the input pulley 24 will be exposed to very high RPM rotations and as such will be designed to operate at and withstand these high RPMs.

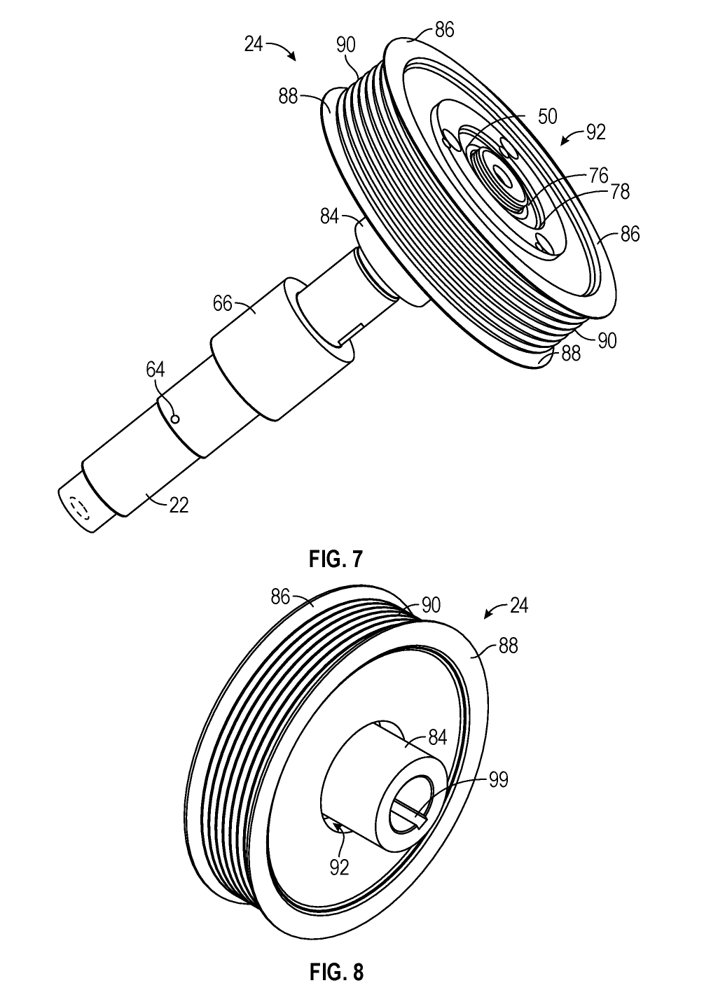

In embodiments of the invention, as best illustrated in FIGS. 8 and 9, the input pulley 24 is a generally flattened cylinder that presents an anterior ridge 86, a posterior ridge 88, and a set of intermediary ridges 90 around the circumference of the cylinder. The anterior ridge 86 and the posterior ridge 88 are configured to receive the serpentine belt 44 therebetween, with the serpentine belt 44 being in contact with the intermediary ridges 90. The input pulley 24 also presents an opening 92 through the center. The opening 92 is configured to receive the freewheel clutch 50, the pulley sleeve 84, and/or the input shaft 22 therethrough. The input sleeve 84 is best illustrated in FIG. 10 and discussed more below.

In embodiments of the invention, the input pulley 24 is configured to rotate relative to the gear case 20. The input pulley 24 is configured to rotate freely relative to the gear case 20, as driven by the serpentine belt 44. The freewheel clutch 50 ensures that while the input pulley 24 may rotate freely relative to the gear case 20, the input shaft 22 and/or the set of timing gears 18 only rotates in the primary direction (depending on the relative position of the at least one freewheel clutch 50, as discussed above).

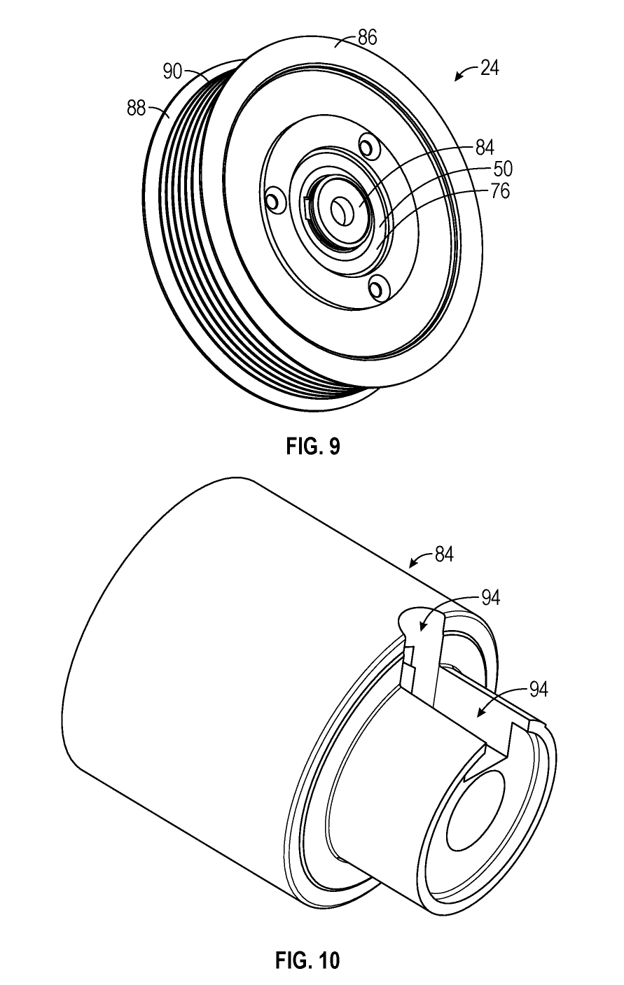

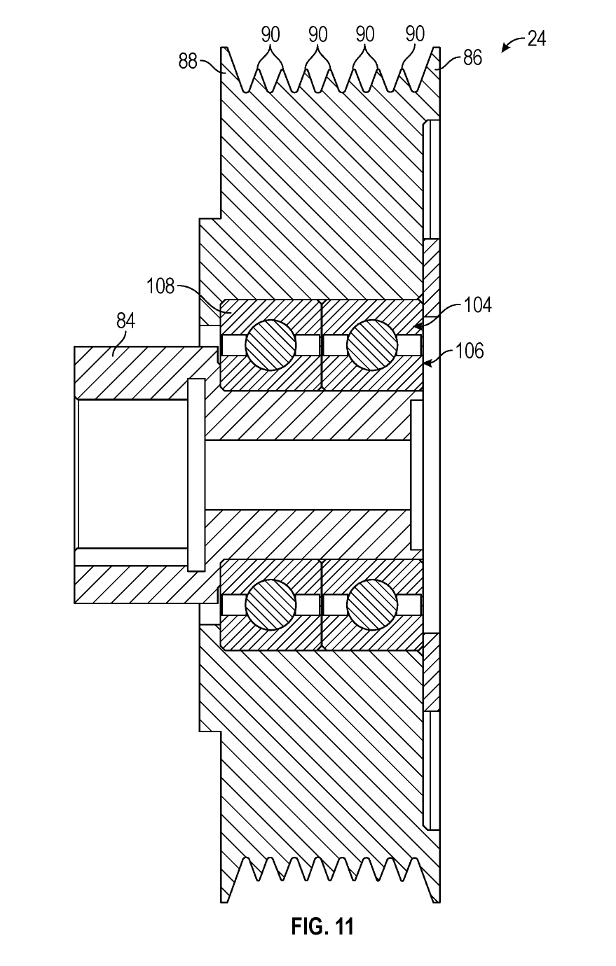

FIG. 11 shows a cross-section of the input pulley 24 from FIG. 8. FIG. 11 shows how the pulley sleeve 84 secures the freewheel clutch 50 within the input pulley 24. As can be seen, the pulley sleeve 84 fits within the freewheel clutch 50 and configured to be secured to the input shaft 22. The input pulley 24 is disposed around the freewheel clutch 50. Therefore, the freewheel clutch 50 is disposed between the input pulley 24 and the pulley sleeve 84. The rotation of the input shaft 22 is tied to the rotation of the pulley sleeve 84. As such, the rotation of the input shaft 22 in the reverse direction can be prevented or reduced by the freewheel clutch 50. The input pulley 24, the freewheel clutch 50, and the pulley sleeve 84 each present a substantially cylindrical or annular shape. The input pulley 24, the freewheel clutch 50, and the pulley sleeve 84 may be substantially concentric as viewed through a vertical cross-section (not illustrated).

FIG. 10 shows an exemplary pulley sleeve 84 that may attach the freewheel clutch 50 to the input shaft 22. The pulley sleeve 84 is generally cylindrical and presents a notch 94 that interfaces with the freewheel clutch 50 and/or the input shaft 22. The pulley sleeve 84 allows the freewheel clutch 50 to be secured to the input shaft 22. In other embodiments, the pulley sleeve 84 does not include a notch 92. Instead, the pulley sleeve 84 may include a recess, a void, a protrusion, a ridge, or other structure (not illustrated) configured to interface with the input shaft 22 so as to allow the pulley sleeve 84 to be secured to an exposed end of the input shaft 22. In embodiments of the invention, the pulley sleeve 84 is utilized so as to allow the input pulley 24 to be replaced without opening the gear case 20. This may allow the input pulley 24 to be replaced upon being worn or to add an input pulley 24 that includes the freewheel clutch 50. As such, embodiments of the invention are configured to be added to existing supercharger system 10s. Because the freewheel clutch 50 is only external to the gear case 20, in embodiments of the invention, existing supercharger system 10s may be retrofitted to reduce the resonance discussed above.

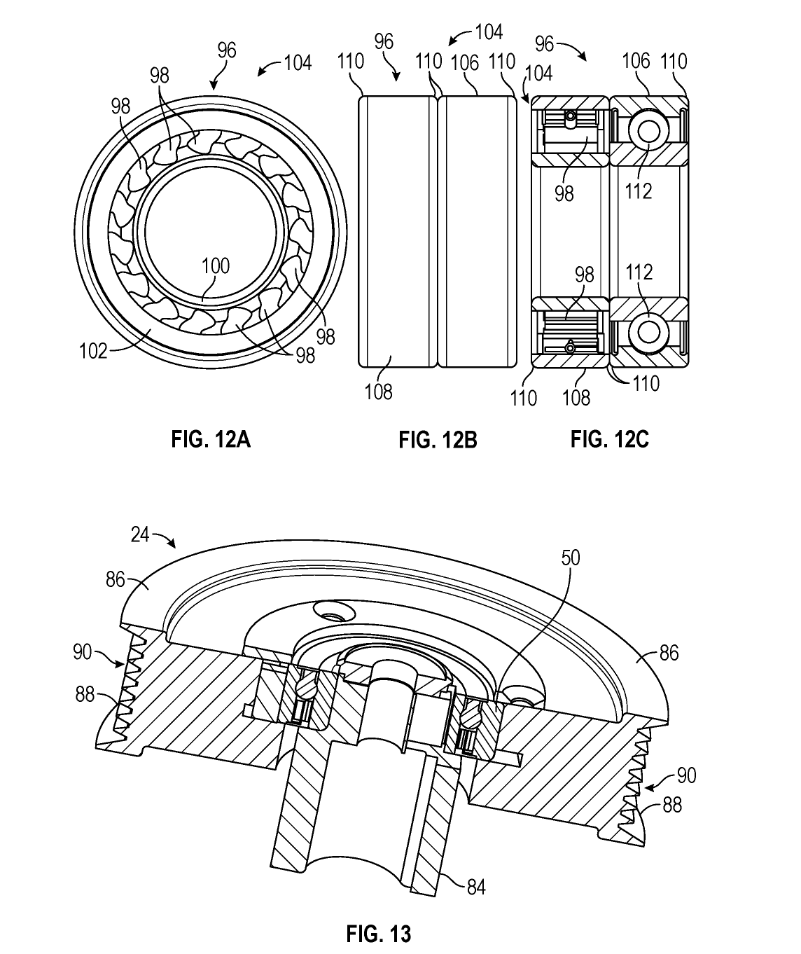

FIGS. 11-13 show various embodiments of the freewheel clutch 50. In one embodiment of the invention, the freewheel clutch 50 is a sprag clutch 96. A sprag clutch 96 is similar to a roller bearing that has asymmetrical sprags 98 therein (in lieu of or in addition to spherical ball bearings) to allow free rotation in one direction and prevent rotation in a second direction. The sprags 98 create a wedging action when a force is applied in the second direction. The wedging action is formed between an inner wall 100 and an outer wall 102 of the sprag clutch 96, as shown in FIG. 12A. The friction of the wedging action prevents the free rotation. The sprag clutch 96 may also include one or more actuators (such as encasing springs around the exterior circumference of the sprags 98) to force the sprags 98 out of engaging. The number and type of actuators may be varied so as to account for the high RPMS at which the sprag clutch 96 may rotate (e.g. to overcome the reactive centrifugal force caused by the rotation of the sprags 98 themselves).

In these embodiments, the freewheel clutch 50 is a dual freewheel clutch 104 in a parallel design, as shown in FIGS. 11 and 12. The freewheel clutch 50 of these embodiments is formed a bearing segment 106 and a clutch segment 108. The bearing segment 106 is configured to allow rotation in the primary direction. The clutch segment 108 is configured to prevent rotation in the reverse direction. As can be seen in FIG. 12B, the bearing segment 106 is distinct from the clutch segment 108. In some embodiments, the bearing segment 106 is disposed adjacent to the clutch segment 108. Each of the bearing segment 106 and the clutch segment 108 present a general annular shape. The annular shape may include a beveled edge 110. The bearing segment 106 may be secured to the clutch segment 108 by a chemical adhesive, by welding, by production with a common interface wall, by a mechanical fastener, or by another securing structure. The freewheel clutch 50 of embodiments may also be a single, monolithic freewheel clutch, as shown in FIG. 13.

FIG. 12C shows a vertical cross-section through the dual freewheel clutch 104. The cross-section shows a view through the respective clutch segment 108 and the bearing segment 106. As can be seen, the bearing segment 106 includes a set of ball bearing 112 that facilitate the rotation of the clutch in the primary direction (and in the reverse direction). The set of ball bearing 112 ensures that rapid and sustained rotations are supported. The clutch segment 108 is a sprag clutch 96 that is independent of the roller clutch. As discussed above, a sprag clutch 96 is similar to a roller bearing that has asymmetrical sprags 98 therein (in lieu of or in addition to spherical ball bearing 112) to allow free rotation in one direction and prevent rotation in a second direction. The sprags 98 create a wedging action when a force is applied in the second direction. The friction of the wedging action prevents the free rotation. The sprag clutch 96 may also include one or more actuators (such as encasing springs around the exterior circumference of the sprags 98) to force the sprags 98 out of engaging. The number and type of actuators may be varied so as to account for the high RPMS at which the sprag clutch 96 may rotate (e.g. to overcome the reactive centrifugal force caused by the rotation of the sprags 98 themselves).

In another embodiment of the invention, the freewheel clutch 50 is a roller clutch (not illustrated). The roller clutch includes a plurality of spherical rollers and a plurality of inclined planes. In the first direction, the rollers are pushed down the plane so as to allow the roller clutch to freely spin. In the second direction, the rollers are pushed up the inclined plane so as to prevent rotation in the second direction. The roller clutch may be capable of withstanding high RPMs without breaking or otherwise failing. The roller clutch may be utilized independently of or in conjunction with the sprag clutch 96 discussed above. In other embodiments, other types of freewheel clutches may be used. The sprag clutch 96, the dual clutch, and the roller clutch are three exemplary types of freewheel clutches that may be utilized in various embodiments of the invention.

The freewheel clutch 50 also produces no or very little resonance when engaging or allowing freewheel movement. In some embodiments, such as where the sprags 98 include a cam and lobe shape, the sprags 98 are engaged by default. This allows the freewheel clutch 50 to rotate in the primary direction with better accuracy without losing power while the sprags 98 engage. In other embodiments, another type of one-directional clutch may be utilized.

It should be appreciated that, while the above disclosure is directed mainly to the field of centrifugal superchargers, some embodiments of the invention are associated with other fields. Some embodiments of the invention are directed to turbochargers, roots-style superchargers, screw-type superchargers, etc. In embodiments of the invention, the input pulley 24 with the freewheel clutch 50 is configured to be installed on existing superchargers. As such, the above-discussed resonance that is prevalent in existing superchargers can be reduced or eliminated. In other embodiments, the freewheel clutch 50 is configured to be originally manufactured with the supercharger system 10, such as in which the first freewheel clutch 78 and the second freewheel clutch 80 50 are disposed within the supercharger system 10.

Various methods of the invention will now be discussed. A first method is directed to a method of reducing resonance in a supercharger system 10, the method comprising the following steps: inserting a freewheel clutch 50 into an input pulley 24; securing the freewheel clutch 50 to the input pulley 24 by applying a pulley sleeve 84 into the freewheel clutch 50; securing an input pulley 24 to an input shaft 22 of the supercharger system 10; securing a serpentine belt 44 around the input pulley 24 and a crank shaft associated with a power source 32, wherein the serpentine belt 44 is configured to drive the input pulley 24 in a primary direction, wherein the freewheel clutch 50 is configured to prevent the input shaft 22 from rotating in a reverse direction that is opposite the primary direction. The freewheel clutch 50 reduces or prevents a resonance generated by the impulses being imparted on the input shaft 22 by the serpentine belt 44. The impulses are imparted on the serpentine belt 44 by a power source 32 that is driving the serpentine belt 44, as discussed above.

In some embodiments, the freewheel clutch 50 is a first freewheel clutch 78. In these embodiments, the method may further comprise the step of installing a second freewheel clutch 80 into a gear case 20 of the supercharger system 10. The second freewheel clutch 80 is configured to prevent rotations of the input shaft 22 in the reverse direction from being imparted on a set of timing gears 18 of the gear case 20.

Although the invention has been described with reference to the embodiments illustrated in the attached drawing figures, it is noted that equivalents may be employed and substitutions made herein without departing from the scope of the invention.

Having thus described various embodiments of the invention, what is claimed as new and desired to be protected by Letters Patent includes the following:

1. A supercharger system configured to be installed in a vehicle having a power source, the super charger system comprising:
an impeller for acquiring air;
a compressor housing surrounding at least a portion of the impeller so as to direct the acquired air toward an internal combustion engine;
an input shaft configured to rotate the impeller;
an input pulley assembly configured to drive the input shaft and interface with a serpentine belt that is associated with the power source,
wherein the input pulley is configured to rotate in a primary direction correlating with rotation of the serpentine belt in the primary direction; and
a freewheel clutch configured to interface with an input shaft of the supercharger,
wherein the freewheel clutch prevents rotation in a reverse direction that is opposite the primary direction.

2. The supercharger system of claim 1, wherein the power source that is associated with the serpentine belt is the internal combustion engine.

3. The supercharger system of claim 1,
wherein a spin ratio is defined as a ratio of a spin rate of the input shaft to a spin rate of the impeller,
wherein the spin ratio is fixed.

4. The supercharger system of claim 1,
wherein a spin ratio is defined as a ratio of a spin rate of the input shaft to a spin rate of the impeller,
wherein the spin ratio is variable such that the spin ratio may be controlled.

5. The supercharger system of claim 1,
wherein the freewheel clutch is disposed between the input pulley and the input shaft,
wherein the freewheel clutch prevents rotation of the input shaft in the reverse direction.

6. The supercharger system of claim 5, further comprising:
a pulley sleeve for securing the freewheel clutch between the input pulley and the input shaft.

7. The supercharger system of claim 1, further comprising:
a set of gears disposed between the input shaft and the impeller,
wherein the input shaft drives the set of gears.

8. The supercharger system of claim 7,
wherein the freewheel clutch is disposed between the input shaft and the set of gears,
wherein the freewheel clutch prevents rotation of the set of gears in the reverse direction.

9. The supercharger system of claim 7,
wherein the freewheel clutch reduces or prevents a resonance generated by an impulse being imparted on the set of gears,
wherein the impulse is in the reverse direction.

10. The supercharger system of claim 7,
wherein the freewheel clutch is a first freewheel clutch,
wherein the first freewheel clutch is disposed between the input pulley and the input shaft,
wherein the first freewheel clutch prevents rotation of the input shaft in the reverse direction.
further comprising:
a second freewheel clutch disposed between the input shaft and the set of gears,
wherein the second freewheel clutch is configured to prevent rotations of the input shaft in the reverse direction from being imparted on the set of gears.

11. The supercharger system of claim 10, further comprising:
a third freewheel clutch disposed between the input shaft and the set of gears,
wherein the second freewheel clutch is configured to prevent rotations of the input shaft in the reverse direction from being imparted on the set of gears.

12. An input pulley assembly configured for providing power to a supercharger for an internal combustion engine, the input pulley assembly comprising:
an input pulley configured to interface with a serpentine belt,
wherein the input pulley is configured to rotate in a primary direction correlating with rotation of the serpentine belt in the primary direction; and
a freewheel clutch configured to interface with an input shaft of the supercharger,
wherein the freewheel clutch is configured to prevent the input shaft from rotating in a reverse direction that is opposite the primary direction.

13. The input pulley assembly of claim 12, wherein the freewheel clutch is disposed between the input pulley and the input shaft.

14. The input pulley assembly of claim 12, further comprising:
a pulley sleeve for securing the freewheel clutch between the input pulley and the input shaft.

15. The input pulley assembly of claim 12,
wherein the freewheel clutch reduces or prevents a resonance generated by the impulses being imparted on the input shaft by the serpentine belt,
wherein the impulses are imparted on the serpentine belt by a power source that is driving the serpentine belt.

16. The input pulley assembly of claim 12, wherein the freewheel clutch comprises:
a bearing segment configured to allow rotation in the primary direction; and
a clutch segment configured to prevent rotation in the reverse direction.

17. The input pulley assembly of claim 16,
wherein the bearing segment is distinct from the clutch segment,
wherein the bearing segment is disposed adjacent to the clutch segment.

18. A method of reducing resonance in a supercharger system, the method comprising the following steps:
inserting a freewheel clutch into an input pulley;
securing the freewheel clutch to the input pulley by applying a pulley sleeve into the freewheel clutch;
securing an input pulley assembly to an input shaft of the supercharger system;
securing a serpentine belt around the input pulley assembly and a crank shaft associated with a power source,
wherein the serpentine belt is configured to drive the input pulley assembly in a primary direction,
wherein the freewheel clutch is configured to prevent the input shaft from rotating in a reverse direction that is opposite the primary direction.

19. The method of claim 18,
wherein the freewheel clutch reduces or prevents a resonance generated by the impulses being imparted on the input shaft by the serpentine belt,
wherein the impulses are imparted on the serpentine belt by a power source that is driving the serpentine belt.

20. The method of claim 18,
wherein the freewheel clutch is a first freewheel clutch,
further comprising the following steps:
installing a second freewheel clutch into a gear case of the supercharger system,
wherein the second freewheel clutch is configured to prevent rotations of the input shaft in the reverse direction from being imparted on a set of gears of the gear case.
